(19) United States
(12) Patent Application Publication
(10) Pub. No.: US 2021/0042719 A1
(43) Pub. Date: Feb. 11, 2021

(54) PORTABLE RESOURCE TRANSMITTAL DEVICE WITH DUAL MESSAGE LIMITER

(71) Applicant: BANK OF AMERICA CORPORATION, Charlotte, NC (US)

(72) Inventors: Lee Ann Proud, Ponte Vedra, FL (US); Joseph Benjamin Castinado, North Glenn, CO (US); Martha Sain McClellan, Lancaster, SC (US); Kathleen Hanko Trombley, Oakboro, NC (US)

(73) Assignee: BANK OF AMERICA CORPORATION, Charlotte, NC (US)

(21) Appl. No.: 16/534,934

(22) Filed: Aug. 7, 2019

(51) Int. Cl. G06Q 20/08; G06Q 20/32; H04W 12/06; H04W 28/16

(52) U.S. Cl. CPC G06Q 20/0855; H04W 28/16; H04W 12/0609; G06Q 20/325

(57) ABSTRACT

Embodiments of the invention are directed to a system, method, or computer program product for paperless and cardless third party resource transfer processing. The invention creates a user experience on a stand-alone device associated with a third party by incorporating resource transfer data and resource transfer input from the user, and displaying the resource transfer data to the user. Wireless communication channels provide the invention with secure, cardless capabilities. The invention may communicate with the user device to receive authentication credentials from the user and transmit a processed total resource allocation to the third party resource transfer system.

### BACKGROUND

With advancements in machine and product development, more and more machines and products are being interconnected via wireless internet channels. Currently the security and efficiency in the field of resource distributions lead to complexity. As such, there is a need for improved resource distribution systems that can provide advanced, efficient, and more secure user communications.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method and computer program product for cardless and paperless resource transfer of allocated resources based on wireless user authentication.

In some embodiments, the invention allows for quicker and more secure resource transfer by eliminating the need for dual messaging and user security breaches. For example, the resource transmittal device will allow users to view resource transfer data from a third party, add or modify a resource transfer input, and verify and authenticate the cardless and paperless resource transfer, all in a single resource transfer message. For example, a user can add a tip or split the bill amongst many users on the portable resource transmittal device. This invention automatically transmits a request for authentication credentials based on smart device signals from the invention and device associated with the user. Subsequently, based on approved authentication by the user, the invention triggers release of user resources to complete the resource transfer. Furthermore, the release of user resources will be wireless, cardless, and paperless, preserving user security, enhancing third party efficiency, and limiting third party dual messaging. Furthermore, the invention may communicate with third party inventory and suppliers to generate an automatic inventory update and order for materials for merchant products based on the completion of one or more steps via the portable resource transmittal device. The invention may also communicate with the third party accounting and back end payroll for efficient resource transfer to individuals associated with the third party.

Embodiments of the invention relate to systems, methods, and computer program products for paperless and cardless third party resource transfer processing, the invention comprising: receiving resource transfer data from a third party resource transfer system, wherein the resource transfer data comprises resource requirements for completion by the user; displaying, on a graphical interface, the resource transfer data to a user; receiving resource transfer input from the user; coordinating the resource transfer input and the resource transfer data into a total resource allocation to a resource distribution account associated with the user; prompting a communicable linkage with a user device associated with the user, wherein the communicable linkage receives authentication credentials from the user device; and transmitting a processed total resource allocation to the third party resource transfer system.

In some embodiments, the invention further comprises performing processing on the third party to conduct one or more transactions across the exchange via a cardless resource transfer, wherein the cardless resource transfer occurs via a communicable link between the third party resource transfer system and the user device.

In some embodiments, the invention further comprising performing processing on the third party resource transfer system to track and total resource transfer data and modify current inventory status, wherein modifying the current inventory status comprises updating product inventory based on the processing.

In some embodiments, receiving the resource transfer data from a third party resource transfer system further comprises an itemized graphical display of resource requirements for completion and selection of resource transfer input by the user associated with user purchases.

In some embodiments, the resource transfer input further comprises an additional resource amount about the resource transfer data that creates a total resource allocation to apply to a resource distribution allocation for user payment to complete a transaction to the third party resource transfer system.

In some embodiments, the resource transfer input further comprises an additional resource amount comprising a portion of the resource transfer data that in combination with other portions creates a total resource allocation, wherein the portion of the resource transfer data is applied to a user payment method to complete a transaction to the third party resource transfer system.

In some embodiments, the invention further comprises fetching authentication credentials, wherein authentication credentials comprise wireless communication between the third party resource transfer system and a user device associated with the user via a communicable link.

In some embodiments, the communicable link further comprises wirelessly transmitting a notification for verification of resource distribution account to the user device.

In some embodiments, the resource transfer input and resource transfer data are totaled and cross-referenced via the third party resource transfer system to ensure correct total resource allocation to the third party resource transfer system.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1A provides a real-time paperless and cardless third party resource transfer processing system environment, in accordance with one embodiment of the present invention;

FIG. 1B provides a portable resource transmittal device, in accordance with one embodiment of the present invention;

FIG. 2A provides a high level process flow illustrating the paperless and cardless third party resource transfer processing device stages, in accordance with one embodiment of the present invention;

FIG. 2B provides a detailed process map illustrating third party enrollment and device programming, in accordance with one embodiment of the present invention;

FIG. 2C provides a detailed process map illustrating real-time resource transfer from a user to the third party resource transfer system, in accordance with one embodiment of the present invention;

FIG. 3 provides a real-time resource transmittal device process involving user modification to a resource transfer input, in accordance with one embodiment of the present invention;

FIG. 4 provides a high level process flow illustrating performing processing on the third party resource transfer system to track and total resource transfer data and modify current inventory status, in accordance with one embodiment of the present invention;

FIG. 5 provides a process flow illustrating communication of user information via authenticating user credentials through smart device communicable linkages, in accordance with one embodiment of the present invention; and

FIG. 6 provides a system environment flow illustrating interactions between the third party resource transfer system, portable resource transmittal system, portable resource transmittal device, and user devices, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “user” as used herein may refer to any customer of a third party or an individual that interacts with the third party. In some embodiments, identities of an individual may include online handles, usernames, aliases, family names, maiden names, nicknames, or the like. For purposes of this invention, the term “user” and “user” may be used interchangeably. Furthermore, as used herein the term “user device” or “mobile device” may refer to mobile phones, personal computing devices, tablet computers, wearable devices, and/or any portable electronic device capable of receiving and/or storing data therein.

“Third party” as used herein may refer to an individual or an organization comprising multiple individuals such as an institution or an association that operates a business, like a bank or restaurant, a non-profit organization, a governmental organization, and the like, which may routinely use various types of applications and devices within its environment to conduct resource transfers with a user.

A “resource transfer system” as used herein may refer to the computing systems, devices, software, applications, communication hardware, and/or other resources used by the third party to perform the functions as described herein. Accordingly, the resource transfer system may comprise desktop computers, laptop computers, servers, mobile smartphones, smart devices, network connections, point of sale terminals, networked terminals, secure keypad, and/or other types of computing systems or devices and/or peripherals along with their associated applications used for resource allocation to the third party. In some embodiments, the resource transfer system may include a portable resource transmittal device, third party resource transfer systems, and/or portable resource transmittal system associated with the portable resource transmittal device.

In the context of example implementations described herein, a “resource requirement,” “resource transfer input,” “total resource allocation,” or “resource distribution account” refers to any transfer of resources to and/or from a user. A resource requirement may refer to a purchase of shares of stock, goods, a return of goods or services, a payment transaction, an itemized or non-itemized receipt depicting the transaction, or other interaction involving a user's account. In the context of a third party, such a financial institution or merchant, a transaction may refer to one or more of: a sale of goods and/or services, initiating an automated teller machine (ATM) or online banking session, an account balance inquiry, a rewards transfer, a user accessing their e-wallet, or any other interaction involving a user and/or the user's device that is detectable by the financial institution. A “user account” is where resources may be extracted from.

Furthermore, “communicable linkage” or “communicable link” may refer to the pathway used for initiating any communication between a user and the financial institution or third party monitoring the user's activities to transfer funds for the purchasing or selling of a product. The pathway may include face-to-face exchanges and electronic exchanges including any transfer of signs, signals, writing, image, sounds, data, or intelligence of any nature transmitted in whole or in part by a wire, radio, network, electromagnetic, or photoelectronic system.

In some embodiments, the invention allows for quicker and safer resource transfer by eliminating the need for dual messaging and user security breaches. For example, the resource transmittal device will allow users to view resource transfer data from a third party, add or modify a resource transfer input, and verify and authenticate the cardless and paperless resource transfer, all in a single resource transfer. For example, a user can add a tip or split the bill amongst many users on the portable resource transmittal device. This invention automatically transmits a request for authentication credentials based on smart device signals from the invention and device associated with the user. Subsequently, based on approved authentication by the user, the invention triggers release of user resources to complete the resource transfer. Furthermore, the release of user resources will be wireless, cardless, and paperless, preserving user security, enhancing third party efficiency, and limiting third party dual messaging. The invention may also communicate with third party inventory and suppliers to generate an automatic inventory update and order for materials for merchant products based on the completion of one or more steps via the portable resource transmittal device.

Furthermore, the invention may also communicate with the third party's back end accounting and payroll system to separate out additional resources added by the user for transfer to individuals associated with the third party, tax the additional resources, and integrate it directly into the individual's pay.

Embodiments of the present invention address the above needs and/or achieve other advantages by providing apparatuses (e.g., a system, computer program product and/or other devices) and methods for cardless and paperless real-time resource transfer between users and third parties.

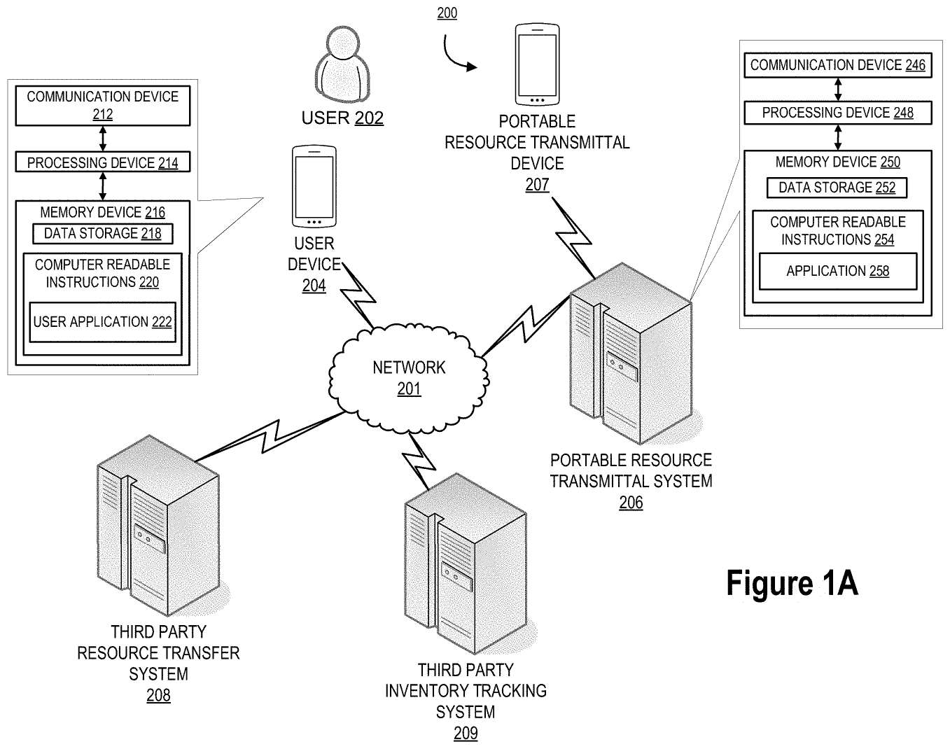

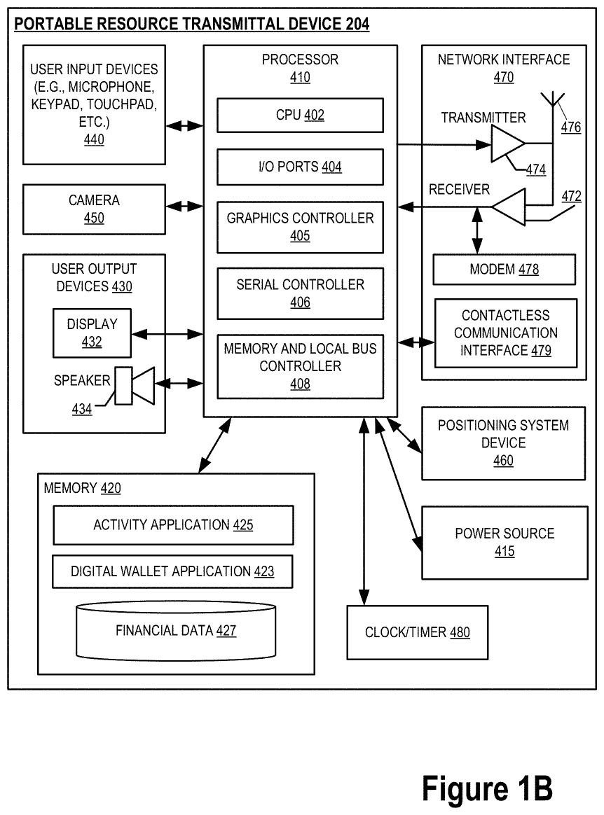

FIG. 1A illustrates a real-time paperless and cardless third party resource transfer processing system environment 200, in accordance with one embodiment of the present invention. FIG. 1A provides the system environment 200 for which the network system with specialized data feeds systems and devices associated with resource transfer between third parties and users. FIG. 1A provides a unique system that includes specialized servers and systems communicably linked across a distributive network required to perform the functions of resource transfer based on smart device interactions and user input.

As illustrated in FIG. 1A, the third party resource transfer system 208 is operatively coupled, via a network 201 to the user device 204, portable resource transmittal device 207, a third party inventory tracking system 209, and to the portable resource transmittal system 206. In this way, the third party resource transfer system 208 can send information to and receive information from the user device 204, portable resource transmittal device 207, and the portable resource transmittal system 206. FIG. 1A illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is a customer of a third party or an individual that interacts with the third party. In some embodiments, the user 202 has a user device, such as a mobile phone, tablet, computer, or the like. FIG. 1A also illustrates a user device 204. The user device 204 may be, for example, a desktop personal computer, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the portable resource transmittal system 206, the third party resource transfer systems 208, and the portable resource transmittal device 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to send and receive communications with the portable resource transmittal system 206.

As further illustrated in FIG. 1A, the portable resource transmittal system 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the third party resource transfer system 208, the portable resource transmittal device 207, and the user device 204. As such, the communication device 246 generally comprises a modem, server, or other device for communicating with other devices on the network 201.

As further illustrated in FIG. 1A, the portable resource transmittal system 206 comprises computer-readable instructions 254 stored in the memory device 250, which in one embodiment includes the computer-readable instructions 254 of an application 258. In some embodiments, the memory device 250 includes data storage 252 for storing data related to the system environment, but not limited to data created and/or used by the release application 258.

In one embodiment of the portable resource transmittal system 206 the memory device 250 stores an application 258. In one embodiment of the invention, the application 258 may associate with applications having computer-executable program code that generate and code a tag for implementation onto a product. Furthermore, the portable resource transmittal system 206, using the processing device 248 codes certain communication functions described herein. In one embodiment, the computer-executable program code of an application associated with the application 258 may also instruct the processing device 248 to perform certain logic, data processing, and data storing functions of the application.

The processing device 248 is configured to use the communication device 246 to communicate with and ascertain data from one or more third party resource transfer systems 208. In the embodiment illustrated in FIG. 1A and described throughout much of this specification, the application 258 may be coded for the third party resource transfer system 208 for communication with other systems and the user, and triggering resource transfer. As such, the application 258 may receive communications from the third party resource transfer systems 208, decrypt and standardize the received communications such that the communications are compatible with the system, and analyze the communications received to facilitate resource transfer from a user to a third party.

As illustrated in FIG. 1A, the portable resource transmittal device 207 is connected to the third party resource transfer system 208, user device 204, and portable resource transmittal system 206. The portable resource transmittal device 207 has the same or similar components as described above with respect to the user device 204 and the portable resource transmittal system 206. While only one portable resource transmittal device 207 is illustrated in FIG. 1A, it is understood that multiple portable resource transmittal devices 207 may make up the system environment 200. The portable resource transmittal device 207 may be associated with one or more financial institutions, insurance corporations, inspection providers, permit providers, material providers, resource allocators and the like. As such, the portable resource transmittal system 206 may communicate with the third party via the third party resource transfer system 208 to notify the third party of the status of resource transmittal from the user.

As illustrated in FIG. 1A, the third party resource transfer system 208 is connected to the portable resource transmittal device 207, user device 204, and portable resource transmittal system 206. The third party resource transfer system 208 has the same or similar components as described above with respect to the user device 204 and the portable resource transmittal system 206. While only one third party resource transfer system 208 is illustrated in FIG. 1A, it is understood that multiple third party resource transfer systems 208 may make up the system environment 200. It is understood that the servers, systems, and devices described herein illustrate one embodiment of the invention. It is further understood that one or more of the servers, systems, and devices can be combined in other embodiments and still function in the same or similar way as the embodiments described herein.

FIG. 1B provides an illustration of the portable resource transmittal device, in accordance with one embodiments of the invention. The portable resource transmittal device 204 may generally include a processing device or processor 410 communicably coupled to devices such as, a memory device 420, user output devices 430 (for example, a user display device 432, or a speaker 434), user input devices 440 (such as a microphone, keypad, touchpad, touch screen, and the like), a communication device or network interface device 470, a power source 415, a clock or other timer 480, a visual capture device such as a camera 450, a positioning system device 460, such as a geo-positioning system device like a GPS device, an accelerometer, and the like, one or more chips, and the like. The processor 410 may further include a central processing unit 402, input/output (I/O) port controllers 404, a graphics controller 405, a serial bus controller 406 and a memory and local bus controller 408.

Furthermore, the portable resource transmittal device 204 may include a communication mechanism to communicate with the user device and to receive and transmit resources from the user device to the third party.

The processor 410 may include functionality to operate one or more software programs or applications, which may be stored in the memory device 420. For example, the processor 410 may be capable of operating applications such as the activity application 425, a digital wallet application 423, or a web browser application. The activity application 425 may then allow the portable resource transmittal device 204 to transmit and receive data and instructions from the computer terminal 120 (for example, via wireless communication or NFC channels), data and instructions from the processing system 130, web content, such as, for example, location-based content and/or other web page content, according to a Wireless Application Protocol (WAP), Hypertext Transfer Protocol (HTTP), and/or the like.

The digital wallet application 423 and the financial data module 427, together may include the necessary circuitry to provide token storage and transmission functionality, transmitter device signal encoding and decoding functionality to the portable resource transmittal device 204, for secure transmission of financial and authentication credential tokens via the contactless communication interface 479 from the user device to the third party. Generally, the financial data module 427 may be a chip in the form of an integrated circuit, a microprocessor, a system-on-a-chip, a microcontroller, or the like. Of note, while FIG. 1A illustrates the financial data module 427 as an element within the portable resource transmittal device 204, it will be apparent to those skilled in the art that the financial data module 427 functionality may be incorporated separately, within other elements in the portable resource transmittal device 204, or may be included in a removable storage device such as an SD card or the like.

The processor 410 may be configured to use the network interface device 470 to communicate with one or more other devices on a network 101 such as, but not limited to the computer terminal 120 and the processing system 130. In this regard, the network interface device 470 may include an antenna 476 operatively coupled to a transmitter 474 and a receiver 472 (together a “transceiver”), modem 478 and a contactless communication interface 479. The processor 410 may be configured to provide signals to and receive signals from the transmitter 474 and receiver 472, respectively. The signals may include signaling information in accordance with the air interface standard of the applicable BLE standard, cellular system of the wireless telephone network and the like, that may be part of the network. In this regard, the portable resource transmittal device 204 may be configured to operate with one or more air interface standards, communication protocols, modulation types, and access types. By way of illustration, the portable resource transmittal device 204 may be configured to operate in accordance with any of a number of first, second, third, and/or fourth-generation communication protocols and/or the like. For example, the portable resource transmittal device 204 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The portable resource transmittal device 204 may also be configured to operate in accordance with non-cellular communication mechanisms, such as via a wireless local area network (WLAN) or other communication/data networks. The portable resource transmittal device 204 may also be configured to operate in accordance Bluetooth® low energy, audio frequency, ultrasound frequency, or other communication/data networks.

The network interface device 470 or communication device 470 may also include a user activity interface presented in user output devices 430 in order to allow a user 102 to execute some or all of processes described herein. The application interface may have access to the hardware, for example, the transceiver, and software previously described with respect to the network interface device 470. Furthermore, the application interface may have the ability to connect to and communicate with an external data storage on a separate system within the network 101. As described above, the portable resource transmittal device 204 includes a display device 432 having a user interface that includes user output devices 430 and/or user input devices 440. The user output devices 430 may include a display 432 (e.g., a liquid crystal display (LCD) or the like) and a speaker 434 or other audio device, which are operatively coupled to the processor 410. The user input devices 440, which may allow the portable resource transmittal device 204 to receive data from the user and/or the user device, may include any of a number of devices allowing the portable resource transmittal device 204 to receive data from a user.

The portable resource transmittal device 204 may further include a power source 415. Generally, the power source 415 is a device that supplies electrical energy to an electrical load. In some embodiment, power source 415 may convert a form of energy such as solar energy, chemical energy, mechanical energy, and the like, to electrical energy. Generally, the power source 415 in a portable resource transmittal device 204 may be a battery, such as a lithium battery, a nickel-metal hydride battery, or the like, that is used for powering various circuits, for example, the transceiver circuit, and other devices that are used to operate the portable resource transmittal device 204. Alternatively, the power source 415 may be a power adapter that can connect a power supply from a power outlet to the portable resource transmittal device 204. In such embodiments, a power adapter may be classified as a power source “in” the portable resource transmittal device 204.

The portable resource transmittal device 204 may also include a memory buffer, cache memory or temporary memory device operatively coupled to the processor 410. Typically, one or more applications 425 and 423, are loaded into the temporarily memory during use. As used herein, memory may include any computer readable medium configured to store data, code, or other information. The memory device 420 may include volatile memory, such as volatile Random Access Memory (RAM) including a cache area for the temporary storage of data. The memory device 420 may also include non-volatile memory, which can be embedded and/or may be removable. The non-volatile memory may additionally or alternatively include an electrically erasable programmable read-only memory (EEPROM), flash memory or the like.

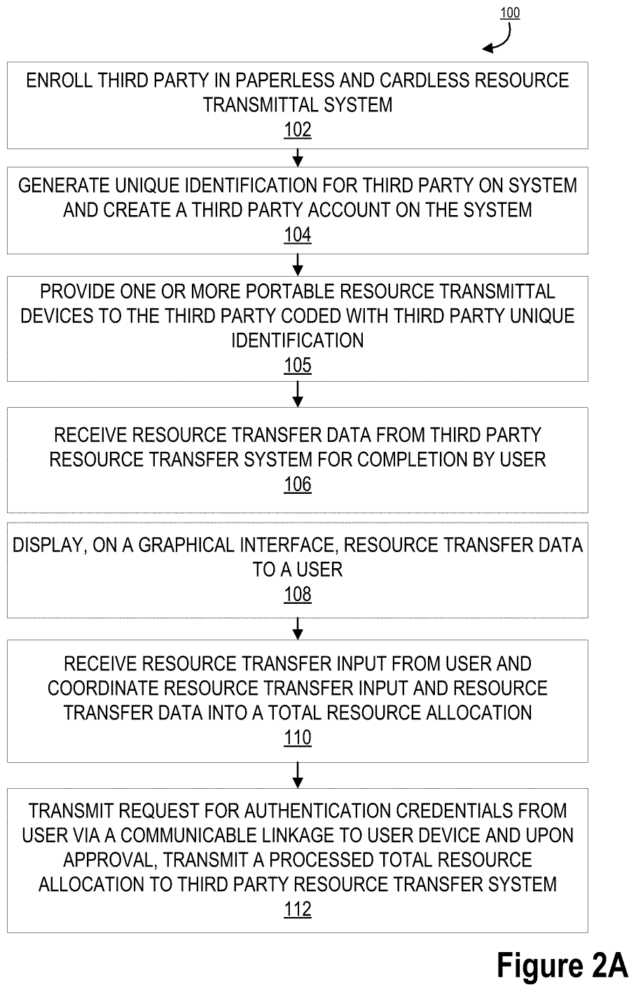

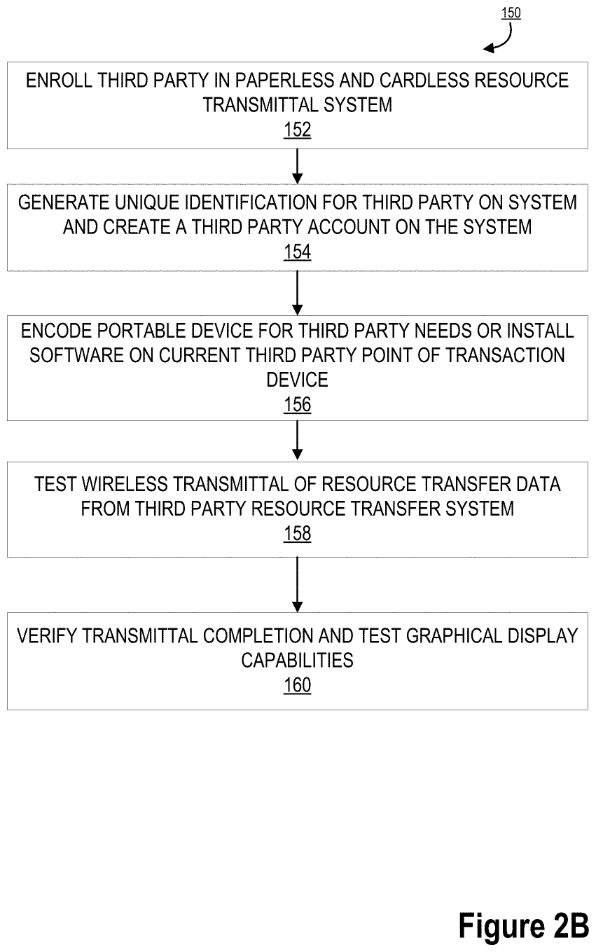

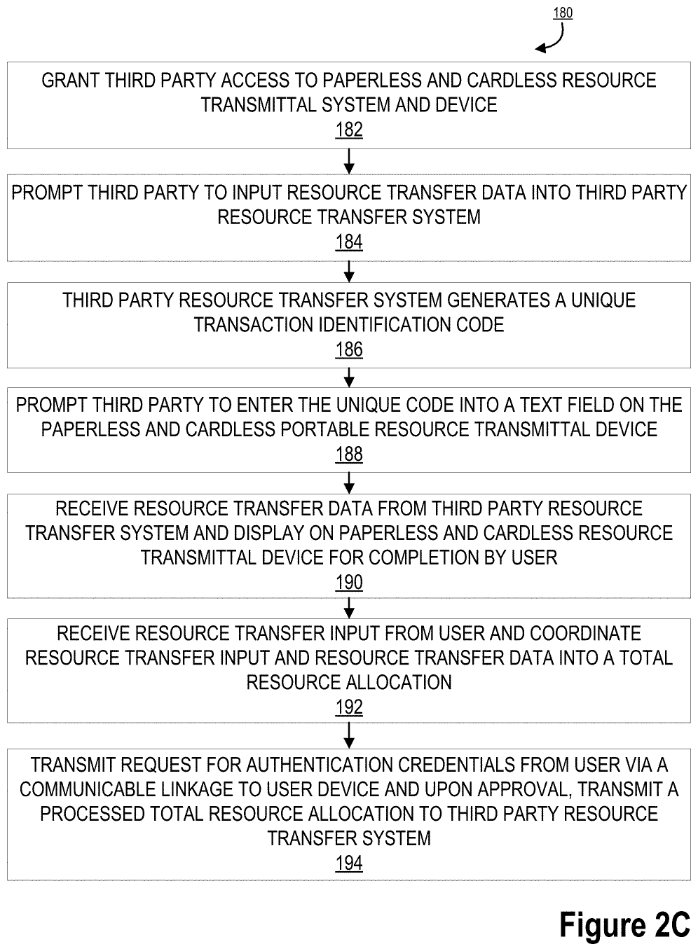

FIG. 2A provides a high level process flow illustrating the paperless and cardless portable third party resource transfer processing stages 100, in accordance with one embodiment of the present invention. As illustrated in block 102, the process 100 is initiated by enrolling a third party in the paperless and cardless portable resource transmittal system. As illustrated in block 104, enrollment may provide the third party with an account on the resource transmittal system and will generate a unique identification for the third party for use on the resource transmittal system. In some embodiments, the unique identification for the third party comprise a user account on the platform including an account number. The unique identification may be a series of random numbers, the third party's phone number, text number, or other numbers associated with the third party.

As illustrated in block 105, the third party may be provided one or more portable resource distribution devices for use at the third party place of business. The portable resource distribution devices may be programmed to include the third party unique identification and be used to complete transactions between users and the third party without requiring dual messaging or physical exchange of payment credentials.

Next, as illustrated in block 106, the process 100 continues by receiving resource transfer data from the third party resource transfer system to await completion by the user. In this way, a user may have completed a transaction with the third party. The user may need to provide a resource distribution to the third party in exchange for the transaction completion. The third party may transmit the required resource transfer request in the form of a resource transfer data request to the system. The system may transmit the resource request to the portable resource transmittal device associated with the third party, based on the unique identifier, for the user to view. The system presents the resource request via the stand alone portable resource transmittal device in a visual format such that the user may visualize the resource request, as illustrated in block 108.

As illustrated in block 110, the process 100 continues by receiving resource transfer input from the user. The user may have a deposit account, such as a transactional account (e.g., a bank account), a savings account, an investment account, a money market account, a time deposit, a dem and deposit, a pre-paid account, a credit account, a non-monetary user profile that includes information associated with the user, or the like. This account information may be stored on a user device. The user may coordinate the user device with the portable resource transmittal device for the transmission of resources from one or more of the user deposit accounts to the portable resource transmittal device. The amount of resources distributed from the user deposit account may be dependent on the resources requested by the third party to complete the transaction. The amount of resources distributed from the user deposit account may also be dependent on the user's resource transfer input. In some embodiments, the user may elect to split the total resource transfer among multiple users, and/or add a tip to the total resource transfer. The user's resource transfer input and the third party's resource transfer data are aggregated into a total resource allocation. The coordination of the user device with the portable resource transmittal device may be based on touch or touchless technology exchange of data.

As illustrated in block 112, the process 100 continues by transmitting a request for authentication credentials from the user via a communicable linkage to a user device. This authentication allows the user, via the user device, to be coordinated with the portable resource transmittal device for secure resource distribution. The system may generate a direct communicable linkage with each of the individual authorized users, if there are multiple users. As such, each communicable linkage may be private, between the system and the individual user and provide a direct portal for account information for the entity and resource transfer via communication between the third party and a financial institution associated with the user. The communicable linkage may be wired or wireless. The communicable linkage will link the third party and user and will present information to the user and third party via a graphical interface on the portable resource transmittal device or user device. The communicable linkage will provide for selective communication to each of the users or third party.

Furthermore, in some embodiments, the system, via the portable device, may link to loyalty accounts associated with the authorized user. The linkage could include recommendations based on user preferences, tie the user to loyalty points, or the like. Furthermore, the loyalty accounts may include processing add on or additional products for utilization based on user preferences and orders.

FIG. 2B provides a detailed process map illustrating third party enrollment and device programming, in accordance with one embodiment of the present invention. As illustrated in block 152, the process 150 is initiated by enrolling a third party in the portable paperless and cardless resource transmittal system. As illustrated in block 154, enrollment may provide the third party with an account on the system, in this way, the system will generate a unique identification for the third party and create the third party account on the system. As such, the third party may have a third party account on the system including an account number and also a unique identification across the system.

Next, as illustrated in block 156, the process 150 continues with installation of software on a third party point of transaction device or encoding the portable resource transmittal device for third party resource transfer needs. The portable resource transmittal device typically provides a graphical interface that allows the user to communicate with the portable resource transmittal device and portable resource transmittal system. The portable resource transmittal software to be installed on the third party point of transaction device or encoding of the portable resource transmittal device may provide different functions and different interfaces to the user to perform one or more steps of process flows described herein. The memory can also store any of several pieces of information to implement functions of the portable resource transmittal device and/or other systems described herein. For example, the memory may include such data as user authentication information.

As illustrated in block 158, the third party can test the wireless and/or wired transmittal of resource transfer data from the third party resource transfer system to verify successful transmission of data. As illustrated in block 160, the third party may also verify transmittal completion and test graphical display capabilities.

FIG. 2C provides a detailed process map illustrating real-time resource transfer from a user to the third party resource transfer system, in accordance with one embodiment of the present invention. The process 180 begins by granting the third party access to paperless and cardless resource transmittal system and the associated portable device, as illustrated in block 182. The portable resource transmittal system will prompt the third party to upload and/or input resource transfer data into the third party resource transfer system, as illustrated in block 184.

Further, block 186 illustrates the third party resource transfer system generating a unique transaction identification code to be used by the third party to import resource transfer data to the portable resource transmittal system. As further illustrated in block 188, the process 180 will prompt the third party to enter the unique code into a text field on the portable resource transmittal system and portable resource transmittal device. When the unique code is entered, the system will utilize the communication device to wirelessly communicate with the third party resource transfer system and the processing device to extract resource transfer data from the third party resource transfer system. The resource transfer data will be stored in the portable resource transmittal system via the memory device and data storage.

The process 180 continues with the portable resource transmittal system receiving and storing the resource transfer data, as illustrated in block 190, via processes described herein. The portable resource transmittal system will then transmit the resource transfer data to the portable resource transmittal device using the communication device. The portable resource transmittal device will display via graphical interface the resource transfer data for completion by user.

As illustrated in block 192, the portable resource transmittal device will receive resource transfer input from the user and will coordinate the resource transfer input and resource transfer data into a total resource allocation 192. As used herein, the term “resource transfer input” generally includes user actions such as splitting a bill or adding tip. As used herein, the term “total resource allocation” may refer to totaling a portion of a resource transfer data that has been split and adding tip to it or taking the entire resource transfer data and adding tip to it.

The process 180 continues in block 194 with the portable resource transmittal device transmitting a request for authentication credentials from a user via a communicable linkage to the user device. Authenticating the user may include authenticating the user device associated with the user over a private security network. The authentication credentials may include a username and password, biometric data, secured authentication tokens, or cryptographic keys. As illustrated in block 194, upon user approval and proper user authentication, the portable resource transmittal device will transmit a processed total resource allocation to the third party resource transfer system for completion of the transaction.

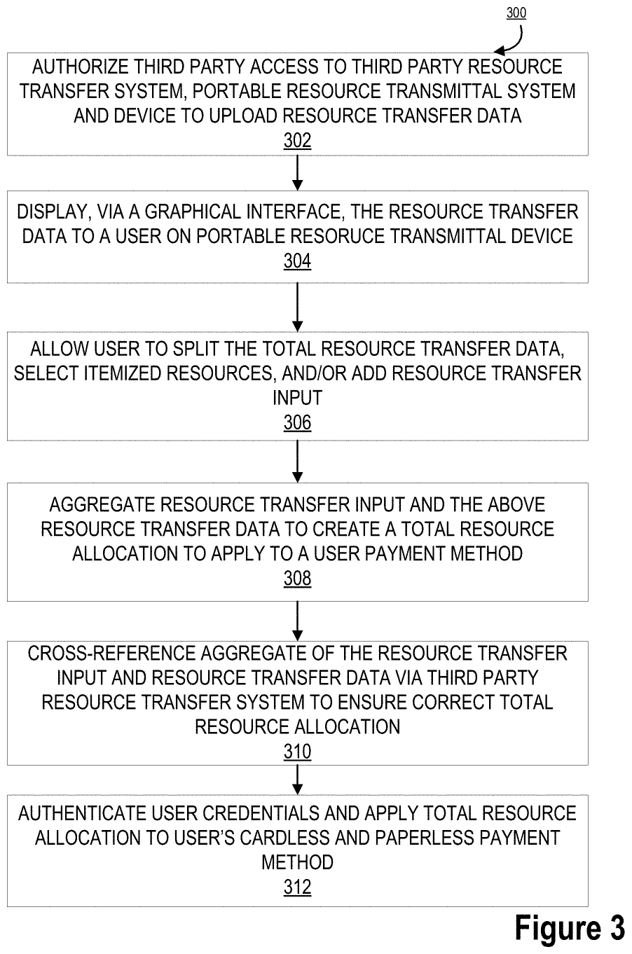

FIG. 3 provides a real-time resource transmittal device process involving user modification to a resource transfer input, in accordance with one embodiment of the present invention. As illustrated in block 302, the process 300 is initiated by authorizing a third party to access the third party resource transfer system, portable resource transmittal system, and portable resource transmittal device to upload resource transfer data for completion by user.

As illustrated in block 304, the process 300 continues by displaying, via a graphical interface, the resource transfer data to a user on the portable resource transmittal device. As illustrated in block 306, the portable resource transmittal device will allow the user to split the total resource transfer data, select itemized resources, and/or add resource transfer input. In this way, the user, via the portable resource transmittal device, may modify their portion of the bill by communicating with the third party resource transfer system via the portable resource transmittal device.

As illustrated in block 308, the process 300 continues by aggregating the resource transfer input and the above resource transfer data to create a total resource allocation to apply to a user payment method. The portable resource transmittal device will aggregate the resource transfer input and resource transfer data to create a total resource allocation. As illustrated in block 310, the process 300 continues by cross-referencing the aggregate of the resource transfer input and resource transfer data via the third party resource transfer system to ensure correct total resource allocation. In this way, if there are multiple users who split the bill and added custom tip, the third party resource transfer system will total the portions of the split bill to ensure that the third party is receiving a total resource allocation.

Further, as illustrated in block 312, the process 300 continues by authenticating user credentials and applying the total resource allocation to the user's cardless and paperless payment method on the user device. The third party will typically provide a secure network for communication between user and third party to authenticate users for payment between user and third party resource transfer system. A third party can be understood to include an individual or an organization that owns and/or operates an online system of networked computing devices, systems, and/or peripheral devices on which the system described herein is implemented. Third parties may be a business organization, like restaurants and banks, or government organizations, and the like, which may routinely use various types of applications within its enterprise environment to accomplish its objectives.

Furthermore, when the third party receives the user's processed resource allocation, the third party resource transfer system will subtract out the resource transfer input designated by the user for payment to individuals associated with the third party. The third party resource transfer system will appropriate tax and integrate the designated resource transfer input with the individual's pay.

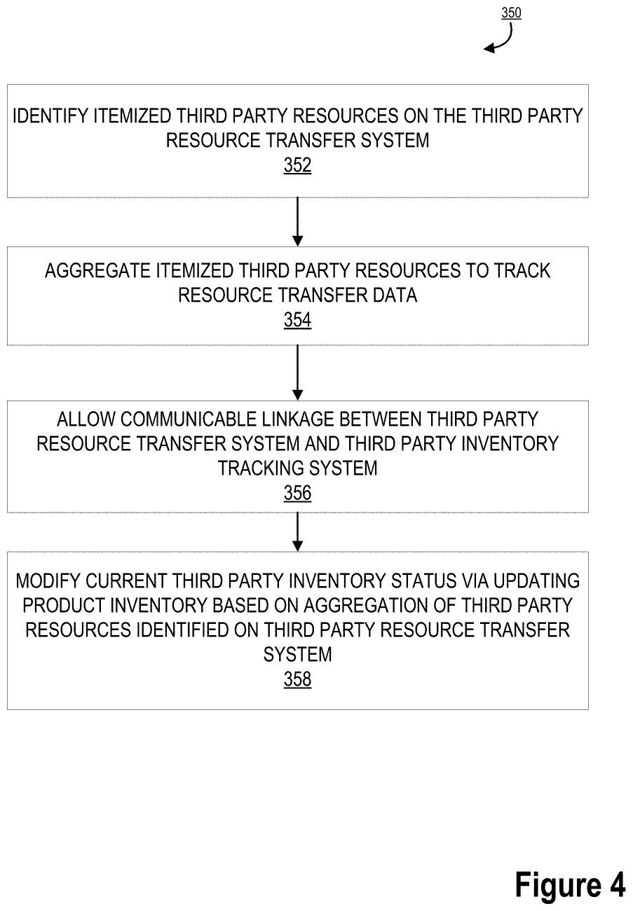

FIG. 4 provides a high level process flow illustrating performing processing on the third party resource transfer system to track and total resource transfer data and modify current inventory status 350, in accordance with one embodiment of the present invention. As illustrated in block 352, the process 350 is initiated by identifying itemized third party resources on the third party resource transfer system. Once a transaction occurs and is paid via the portable resource transmittal device and portable resource transmittal system, the system may be able to perform back end searching to look up an itemized resource transfer. As illustrated in block 354, the process 350 will aggregate the itemized third party resources to begin tracking resource transfer data for inventory purposes. In this way, the system identifies total third party resources associated with resources the third party distributes.

The process 350 continues in block 356 by allowing a communicable linkage between the third party resource transfer system and the third party inventory tracking system. As such, the system may examine market changes in the inventory and provide the third party with a time frame to purchase inventory and a recommended way (cash, credit, or the like) to purchase the inventory. The system may also track trending data, past orders of the third party, and the like, to predict inventory requirements for the third party.

As illustrated in block 358, the process 350 continues by modifying the current third party inventory status via updating product inventory based on aggregation of third party resources identified on the third party resource transfer system. The process 350 may present inventory purchase recommendations based on analysis of total resource transfer for products of the inventory and recommend price fluctuation for the products of the inventory based on popular demand. The process 350 may notify the third party of diminishing inventory based on resource transfer data and recommend a time frame to purchase inventory.

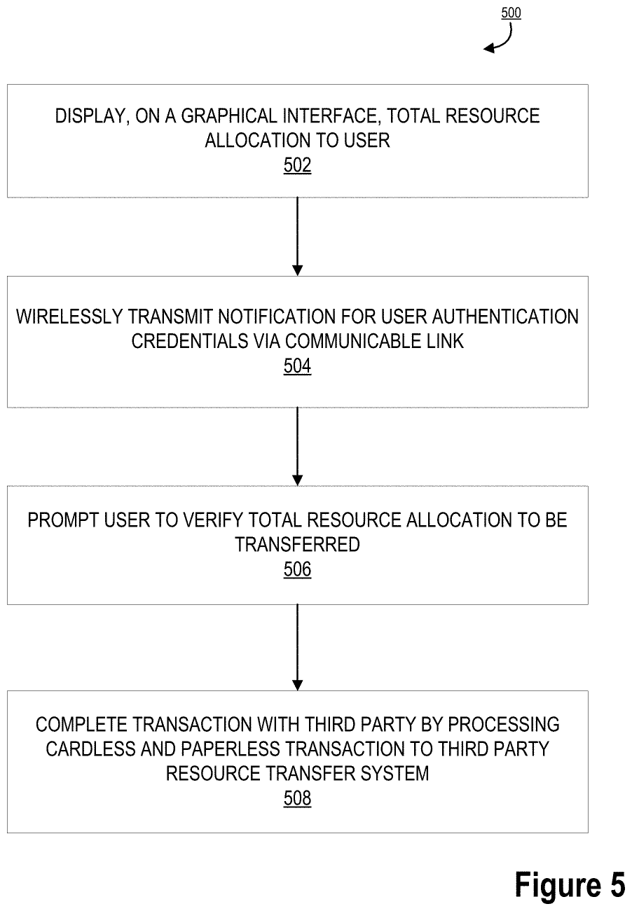

FIG. 5 provides a process flow illustrating communication of user information via authenticating user credentials through smart device communicable linkages, in accordance with one embodiment of the present invention. As illustrated in block 502, the process 500 is initiated by displaying, on a graphical interface, the total resource allocation to the user on the portable resource transmittal device. When the user has modified the total resource allocation and is ready for payment, as illustrated in block 504, the process 500 will wirelessly transmit a notification for user authentication credentials via a communicable link to the user device. As such, authenticating the user includes authenticating the user device over a private and secure network. The portable resource transmittal device, portable resource transmittal system, and third party resource transfer system, will receive authentication credentials from the user device, the authentication credentials including a username and password, biometric data, secured authentication tokens, or cryptographic keys.

As illustrated in block 506, the process 500 will continue by prompting the user to verify the total resource allocation to be transferred and communicating to a financial institution to pay to the third party. As such, this communication will still be taking place over a private and secure network. The communication will occur between a user and a third party, which may be a financial institution or account manager associated with the user's financial institution.

As illustrated in block 508, the process 500 continues by completing the transaction with the third party by processing the cardless and paperless transaction to the third party resource transfer system.

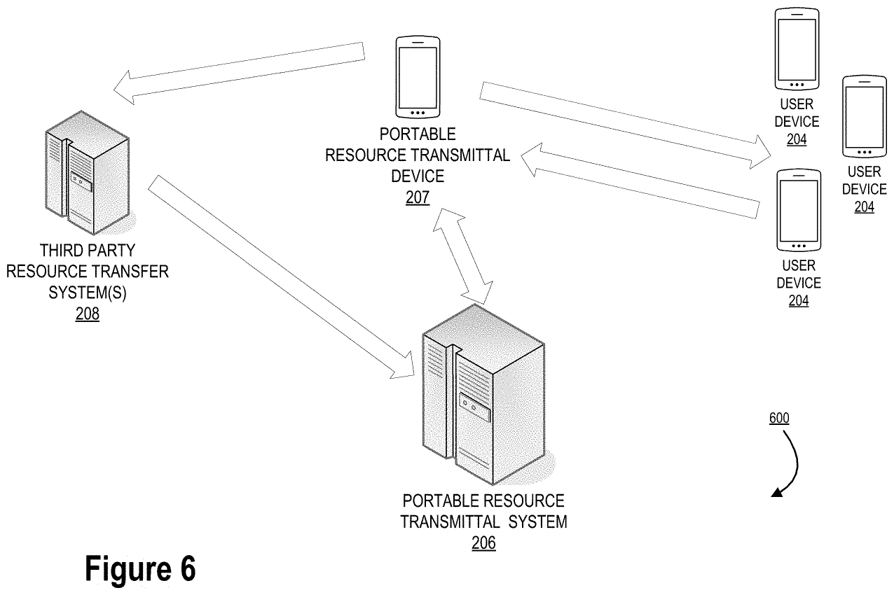

FIG. 6 provides a system environment flow illustrating interactions between the third party resource transfer system, portable resource transmittal system, portable resource transmittal device, and user devices, in accordance with one embodiment of the present invention. The process 600 is initiated at the third party resource transfer system. The third party will upload resource transfer data to the third party resource transfer system and the resource transfer data will be transmitted to the portable resource transmittal system. The portable resource transmittal system will communicate with the portable resource transmittal device and transmit resource transfer data to the device. The portable resource transmittal device will communicate with user device(s) for payment. A user will be able to modify resource transfer data to generate a total resource allocation for payment by user. the portable resource transmittal device and portable resource transmittal system will transmit a request for authentication credentials from the user through the user device via a communicable linkage to the user device. Upon approval by user, the user device will transmit a processed total resource allocation to the portable resource transmittal device and third party resource transfer system.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for paperless and cardless third party resource transfer processing, the system comprising:
a memory device with computer-readable program code stored thereon;
a communication device;
a processing device operatively coupled to the memory device and the communication device, wherein the processing device is configured to execute the computer-readable program code to:
receive resource transfer data from a third party resource transfer system, wherein the resource transfer data comprises resource requirements for completion by the user;
display, on a graphical interface, the resource transfer data to a user;
receive resource transfer input from the user;
coordinate the resource transfer input and the resource transfer data into a total resource allocation to a resource distribution account associated with the user;
prompt a communicable linkage with a user device associated with the user, wherein the communicable linkage receives authentication credentials from the user device; and
transmit a processed total resource allocation to the third party resource transfer system.

2. The system of claim 1, further comprising performing processing on the third party to conduct one or more transactions across the exchange via a cardless resource transfer, wherein the cardless resource transfer occurs via a communicable link between the third party resource transfer system and the user device.

3. The system of claim 1, further comprising performing processing on the third party resource transfer system to track and total resource transfer data and modify current inventory status, wherein modifying the current inventory status comprises updating product inventory based on the processing.

4. The system of claim 1, further comprising integrating the third party resource transfer system with the third party accounting and payroll, wherein additional resources added by the user for transfer to individuals associated with the third party will automatically be taxed and integrated into the individual's pay.

5. The system of claim 1, wherein receiving resource transfer data from a third party resource transfer system further comprises an itemized graphical display of resource requirements for completion/selection of resource transfer input by the user associated with user purchases.

6. The system of claim 1, wherein resource transfer input comprises an additional resource amount above the resource transfer data that creates a total resource allocation to apply to a resource distribution allocation for user payment to complete a transaction to the third party resource transfer system.

7. The system of claim 1, wherein resource transfer input further comprises an additional resource amount comprising a portion of the resource transfer data that in combination with other portions creates a total resource allocation, wherein the portion of the resource transfer data is applied to a user payment method to complete a transaction to the third party resource transfer system.

8. The system of claim 1, wherein authentication credentials comprise wireless communication between the third party resource transfer system and a user device associated with the user via a communicable link.

9. The system of claim 1, wherein the communicable link further comprises wirelessly transmitting a notification for verification of resource distribution account to the user device.

10. The system of claim 1, wherein the resource transfer input and resource transfer data are totaled and cross-referenced via the third party resource transfer system to ensure correct total resource allocation to the third party resource transfer system.

11. A computer program product for paperless and cardless third party resource transfer processing, the computer program product comprising at least one non-transitory computer-readable medium having computer-readable program code portions embodied therein, the computer-readable program code portions comprising:
an executable portion configured for receiving resource transfer data from a third party resource transfer system, wherein the resource transfer data comprises resource requirements for completion by the user;
an executable portion configured for displaying, on a graphical interface, the resource transfer data to a user;
an executable portion configured for receiving resource transfer input from the user;
an executable portion configured for coordinating the resource transfer input and the resource transfer data into a total resource allocation to a resource distribution account associated with the user;
an executable portion configured for prompting a communicable linkage with a user device associated with the user, wherein the communicable linkage receives authentication credentials from the user device; and
an executable portion configured for transmitting a processed total resource allocation to the third party resource transfer system.

12. The computer program product of claim 11, further comprising an executable portion configured for performing processing on the third party to conduct one or more transactions across the exchange via a cardless resource transfer, wherein the cardless resource transfer occurs via a communicable link between the third party resource transfer system and the user device.

13. The computer program product of claim 11, further comprising an executable portion configured for performing processing on the third party resource transfer system to track and total resource transfer data and modify current inventory status, wherein modifying the current inventory status comprises updating product inventory based on the processing.

14. The computer program product of claim 11, wherein receiving resource transfer data from a third party resource transfer system further comprises an itemized graphical display of resource requirements for completion/selection of resource transfer input by the user associated with user purchases.

15. The computer program product of claim 11, wherein resource transfer input further comprises an additional resource amount comprising a portion of the resource transfer data that in combination with other portions creates a total resource allocation, wherein the portion of the resource transfer data is applied to a user payment method to complete a transaction to the third party resource transfer system.

16. A computer-implemented method for paperless and cardless third party resource transfer processing, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving resource transfer data from a third party resource transfer system, wherein the resource transfer data comprises resource requirements for completion by the user;
displaying, on a graphical interface, the resource transfer data to a user;
receiving resource transfer input from the user;
coordinating the resource transfer input and the resource transfer data into a total resource allocation to a resource distribution account associated with the user;
prompting a communicable linkage with a user device associated with the user, wherein the communicable linkage receives authentication credentials from the user device; and
transmitting a processed total resource allocation to the third party resource transfer system.

17. The computer-implemented method of claim 16, further comprising performing processing on the third party to conduct one or more transactions across the exchange via a cardless resource transfer, wherein the cardless resource transfer occurs via a communicable link between the third party resource transfer system and the user device.

18. The computer-implemented method of claim 16, further comprising performing processing on the third party resource transfer system to track and total resource transfer data and modify current inventory status, wherein modifying the current inventory status comprises updating product inventory based on the processing.

19. The computer-implemented method of claim 16, wherein receiving resource transfer data from a third party resource transfer system further comprises an itemized graphical display of resource requirements for completion/selection of resource transfer input by the user associated with user purchases.

20. The computer-implemented method of claim 16, wherein resource transfer input further comprises an additional resource amount comprising a portion of the resource transfer data that in combination with other portions creates a total resource allocation, wherein the portion of the resource transfer data is applied to a user payment method to complete a transaction to the third party resource transfer system.
